(19) United States
(12) Patent Application Publication
(10) Pub. No.: US 2014/0316962 A1
(43) Pub. Date: Oct. 23, 2014

(54) Post-Order Management of Financial Instruments

(71) Applicant: Chicago Mercantile Exchange Inc., Chicago, IL (US)

(72) Inventors: Dhiraj Bawadhankar, Aurora, IL (US); Fateen Sharaby, Hoboken, NJ (US); Sunhil Cutinho, Chicago, IL (US)

(73) Assignee: Chicago Mercantile Exchange Inc., Chicago, IL (US)

(21) Appl. No.: 14/033,276

(22) Filed: Sep. 20, 2013

Related U.S. Application Data
(60) Provisional application No. 61/814,049, filed on Apr. 19, 2013.

(51) Int. Cl. G06Q 40/00

(52) U.S. Cl. CPC G06Q 40/04
USPC 705/37

(57) ABSTRACT

Methods for managing a plurality of orders for a financial instrument includes accepting the plurality of orders for clearing; sending a cleared confirmation message indicating that the plurality of orders has been cleared; receiving notification instructions to group the plurality of cleared orders; terminating the plurality of cleared orders and creating a new order; and sending a cleared confirmation message for the new order. Systems for electronically managing a plurality of orders for a financial instrument and computer-readable media are described.

### RELATED APPLICATIONS

This application claims the priority benefit of U.S. Provisional Application No. 61/814,049, filed Apr. 19, 2013. The entire contents of the provisional application are incorporated herein by reference, except that in the event of any inconsistent disclosure or definition from the present specification, the disclosure or definition herein shall be deemed to prevail.

### BACKGROUND

A derivative is a financial instrument that derives its value from the value of an underlying entity, such as a physical commodity (e.g., agricultural products, mined resources, etc.) or a financial instrument (e.g., stocks, bonds, currencies, interest rates, financial indices, etc.). Derivatives may be broadly classified into two groups: (1) exchange-traded derivatives (e.g., futures, options on futures, etc.), which are traded on a futures exchange (“Exchange”); and (2) over-the-counter (OTC) derivatives (e.g., forwards, swaps, etc.), which are bilateral contracts privately traded between two parties without supervision from an Exchange.

The Chicago Mercantile Exchange Inc. (CME) is one example of an Exchange, which provides a contract market where financial instruments, such as futures and options on futures, are traded. The term “futures” is used to designate all contracts for the purchase or sale of financial instruments or physical commodities for future delivery or cash settlement on a commodity futures exchange. A futures contract is a legally binding agreement to buy or sell a commodity at a specified price at a predetermined future time. By way of example, an interest rate futures contract, also referred to as an interest rate future, is a futures contract having an underlying instrument/asset that pays interest, for which the parties to the contract are a buyer and a seller agreeing to the future delivery of the interest-bearing asset, or a contractually specified substitute. Such a futures contract permits a buyer and seller to lock in the price, or in more general terms the interest rate exposure, of the interest-bearing asset for a future date.

In contrast to a futures contract, an option is the right, but not the obligation, to sell or buy the underlying instrument (e.g., a futures contract) at a specified price within a specified time. The commodity to be delivered in fulfillment of the contract or, alternatively, the commodity for which the cash market price shall determine the final settlement price of the futures contract, is known as the contract's underlying reference or “underlier.” The terms and conditions of each futures contract are standardized as to the specification of the contract's underlying reference commodity, the quality of such commodity, quantity, delivery date, and means of contract settlement (e.g., cash settlement, physical sale and purchase of the underlying reference commodity, etc.).

In the case of exchange-traded derivatives, an Exchange typically provides for a centralized “Clearing House” through which all trades made must be confirmed, matched, and settled each day until offset or delivered. The Clearing House is an adjunct to the Exchange, and may be an operating division of the Exchange, which is responsible for settling trading accounts, clearing trades, collecting and maintaining performance bond funds, regulating delivery, and reporting trading data. Clearing is the procedure through which the Clearing House becomes buyer to each seller of a futures contract and seller to each buyer (also known as novation), and assumes responsibility for protecting buyers and sellers from financial loss due to breach of contract by assuring performance on each contract. A Clearing Member is a firm qualified to clear trades through the Clearing House.

In the case of the CME's Clearing House, all Clearing Members not specifically designated as Class B members are considered Class A Clearing Members. In the CME there are three categories of Clearing Members: 1) the CME Clearing Members, qualified to clear transactions for all commodities; 2) International Monetary Market (IMM) Clearing Members, qualified to clear trades for only IMM and Index and Option Market (IOM) commodities; and 3) IMM Class B Clearing Members, solely limited to conducting proprietary arbitrage in foreign currencies between a single Exchange-approved bank and the IMM and who must be guaranteed by one or more Class A non-bank CME or IMM Clearing Member(s). A “member” is a broker/trader registered with the Exchange.

As an intermediary, the Exchange bears a certain amount of risk in each transaction that takes place. To that end, risk management mechanisms protect the Exchange via the Clearing House. Indeed, a key role of the Clearing House is the mitigation of credit risk. For example, the Clearing House establishes clearing level performance bonds (margins) for all Exchange products and establishes minimum performance bond requirements for customers of Exchange products. A performance bond, also referred to as a margin, is the funds that must be deposited by a customer with his or her broker, by a broker with a Clearing Member, or by a Clearing Member with the Clearing House for the purpose of insuring the broker or Clearing House against loss on open futures or options contracts. This is not a partial payment on a purchase. Rather, the performance bond helps to ensure the financial integrity of brokers, Clearing Members, and the Exchange as a whole. The performance bond to Clearing House refers to the minimum dollar deposit that is required by the Clearing House from Clearing Members in accordance with their positions. Maintenance, or maintenance margin, refers to a sum, usually smaller than the initial performance bond, which must remain on deposit in the customer's account for any position at all times.

The accounts of individual members, clearing firms, and non-member customers doing business through the Exchange must be carried and guaranteed to the Clearing House by a Clearing Member. As described above, in every matched transaction executed through the Exchange's facilities, the Clearing House is substituted as the buyer to the seller and the seller to the buyer, with a Clearing Member assuming the opposite side of each transaction. The Clearing House is an operating division of the Exchange, and all rights, obligations, and/or liabilities of the Clearing House are rights, obligations, and/or liabilities of the Exchange. Clearing Members assume full financial and performance responsibility for all transactions executed through them and all positions they carry. The Clearing House, dealing exclusively with Clearing Members, holds each Clearing Member accountable for every position it carries regardless of whether the position is being carried for the account of an individual member, for the account of a non-member customer, or for the Clearing Member's own account. Conversely, as the contra-side to every position, the Clearing House is held accountable to the Clearing Members for the net settlement from all transactions on which it has been substituted as provided in the Rules.

The Clearing House does monitor Clearing Members for the adequacy of credit monitoring and risk management of their customers. In addition, although the Exchange has established character and financial standards for its individual members, the Clearing House looks solely to the Clearing Member carrying and guaranteeing the account to secure all payments and performance bond obligations. Further, when an individual member executes orders for a Clearing Member, his or her guarantor Clearing Member is held accountable as principal for the brokered transaction until the transaction has been matched and recorded by the Clearing House as a transaction of the Clearing Member for whom the individual member had acted.

While exchange-traded derivatives are structured with standard terms such as contract size, maturity, expiration date, etc. set by an Exchange such as the CME and cleared via the clearing house for settlement, OTC derivatives, by contrast, are more flexible because, typically, none of the business terms of an OTC derivative are standardized. In addition, the settlement of the trade usually occurs directly through the trading parties since no third party Clearing House exists due to the diversity of different derivatives. Accordingly, by contrast to exchange-traded derivatives, privately traded OTC derivatives are typically associated with higher counterparty risk since the above-described risk management mechanisms implemented by the Exchange may not be in place. Notwithstanding, the OTC derivative market is robust—particularly vis-à-vis certain financial instruments, such as swaps and forwards, and in certain classes of assets, such as interest rates, foreign currencies, equities, and commodities.

OTC derivatives can include swaps, options, caps, floors, corridors, etc. derived from interest rates, foreign currencies, equities and other commodities or financial instruments. Trades of OTC derivatives may be made directly with a counterparty, or by phone, or more recently, via an electronic platform such as the Internet. Such trades are recorded by the traders on their trade notebooks and trade data is entered directly into their company's trade data capture computer systems. These systems generate confirmation documents and summary data relating to the trade. More recently, third party validation/confirmation services have emerged which generally perform an independent review and confirmation of the terms of an OTC trade in order to provide assurances to the parties as to their mutual understanding of those terms.

By way of example, an example of an OTC derivative that may be traded between parties is an interest rate swap (IRS). An IRS is a contractual agreement between two parties (i.e., the counterparties), where one stream of future interest payments is exchanged for another (e.g., a stream of fixed interest rate payments in exchange for a stream of floating interest rate payments, based on a specified principal amount). An IRS may be used to limit or manage exposure to fluctuations in interest rates. One common form of IRS exchanges a stream of floating interest rate payments on the basis of the 3-month London interbank offered rate (LIBOR) for a stream of fixed-rate payments on the basis of the swap's fixed interest rate. Another common form of IRS, known as an overnight index swap, exchanges at its termination a floating rate payment determined by daily compounding of a sequence of floating interest rates on the basis of an overnight interest rate reference (e.g., the US daily effective federal funds rate, or the European Overnight Index Average (EONIA)) over the life of the swap, for a fixed rate payment on the basis of daily compounding of the overnight index swap's fixed interest rate over the life of the swap.

Another example of an OTC derivative is an interest rate swap futures contract. An IRS futures contract is a futures in which the underlying instrument is an interest rate swap. As such, an interest rate swap futures contract permits “synthetic” exposure to the underlying interest rate swap (e.g., without entailing actual ownership of the underlying IRS).

### BRIEF DESCRIPTION OF THE DRAWINGS

FIG. 1 shows an overview of a representative order grouping method in accordance with the present teachings.

FIG. 2 shows a flow chart of a representative example of order submission in an order grouping method in accordance with the present teachings.

FIG. 3 shows a flow chart of a representative example of a process for sending grouping instructions in an order grouping method in accordance with the present teachings.

FIG. 4 shows a flow chart of a representative example of creating a new order in an order grouping method in accordance with the present teachings.

FIG. 5 shows a representative general computer system 400 for use with a system in accordance with the present teachings.

### DETAILED DESCRIPTION

Oftentimes, an external counterparty seeking to purchase a certain quantity of a particular derivative—either from an Exchange, in the case of an exchange-traded derivative, or from one or more separate external counterparties, in the case of an OTC derivative—will elect to execute multiple orders for lesser quantities of the product rather than executing a single order for the entire quantity of the product. One of the motivations for executing multiple smaller orders to cobble together the desired quantity of product as opposed to ordering the full desired quantity outright in a single transaction is to obtain better pricing. By way of example, Counterparty 1 (CP1) may be an asset manager responsible for filling an order with a quantity of $100 million for four different clients. Instead of executing a single order with Counterparty 2 (CP2) at a price of $10K, CP1 may spread the liquidity across multiple counterparties to obtain a better price. Thus, CP1 may execute four (or more or fewer) separate orders: one with a quantity of $40 M with CP2 at a price of $3 K, one with a quantity of $15 M with CP3 at a price of $1 K, one with a quantity of $25 M with CP4 at a price of $2 K, and one with a quantity of $20 M with CP5 at a price of $2 K. The total price paid by CP1 to fill the order is now $8 k. After execution, CP1 sends these orders to a Clearing House. However, after clearing is complete, CP1 must allocate an even amount ($25 M) across the four different clients. To perform this action, orders need to be grouped in order to be split evenly across client accounts. Clients must be charged the same price for like transactions, and Asset Managers must not favor one account over another. At present, existing systems lack the ability to “group” orders executed at different prices, post-clearing. Additionally, advantages in pricing may be offset by increased complications associated with processing and accounting for a multiplicity of orders as opposed to a single order. Moreover, current systems are unable to net orders in real-time. As such, a multiplicity of original orders remains open and a single new order cannot be created.

Methods and systems for financial instrument (e.g., derivatives and the like) order grouping have been discovered and are described hereinbelow. In some embodiments, methods and systems in accordance with the present teachings can provide an external counterparty with the ability to submit multiple individual orders for clearing and to have the orders grouped post-clearing into a single new order having economics that substantially mirror the economics of the individual orders. In some embodiments, all or a subset of the individual orders submitted for clearing have been executed at different prices. In other embodiments, the individual orders submitted for clearing have been executed at the same price.

In accordance with the present teachings, the original counterparties (e.g., CP2, CP3, etc.) may not be impacted by the order grouping process. Thus, in accordance with the present teachings, there is no need to inform the original counterparties prior to submission to Clearing that the action of grouping is to take place. In some embodiments, the counterparty to the client that requests grouping is the Exchange (e.g., CME).

Throughout this description and in the appended claims, the following definitions are to be understood:

The phrase “coupled with” is defined to mean directly connected to or indirectly connected through one or more intermediate components. Such intermediate components may include both hardware and software based components.

As used in the pending claims and to hereby provide notice to the public, the phrases “at least one of <A>, <B>, . . . and <N>” or “at least one of <A>, <B>, . . . <N>, or combinations thereof” are defined in the broadest sense, superseding any other implied definitions herebefore or hereinafter unless expressly asserted to the contrary, to mean one or more elements selected from the group comprising A, B, . . . and N, that is to say, any combination of one or more of the elements A, B, . . . or N including any one element alone or in combination with one or more of the other elements which may also include, in combination, additional elements not listed.

While some embodiments described herein may make reference to the CME, it is to be understood that the present teachings are in no way restricted to the CME or, for that matter, to any specific Exchange. On the contrary, the present teachings are applicable to any Exchange, including but not limited to ones that trade in equities and/or other securities.

As noted above, an external counterparty seeking to purchase a certain quantity of a particular derivative—either from an Exchange, in the case of an exchange-traded derivative, or from one or more separate external counterparties, in the case of an OTC derivative—may elect to execute multiple orders for lesser quantities of the product rather than executing a single order for the entire quantity of the product. One motivation for executing multiple smaller orders to cobble together the desired quantity of product as opposed to ordering the full desired quantity outright through a single transaction is to obtain better pricing. However, as Counterparties may choose to send these smaller orders to a Clearing House once executed, a mechanism to group these “cleared” orders into a single order to be spread evenly across client accounts is needed. The handling of a multiplicity of orders is significantly more complex than the corresponding handling of a single order, in which all cleared orders are terminated at the Clearing House and replaced with a single order, which is then allocated evenly across multiple accounts.

At present, existing systems, specifically ones that process OTC derivatives, do not need the ability to “group” orders executed at different prices, post-clearing, into a single new order. This is because OTC derivatives are currently executed between two counterparties on a bilateral basis. For example, Counterparty 1 will physically call Counterparty 2 to fill an entire order. In the future, OTC derivative transactions may be executed on a Central Limit Order Book (GLOB) in which multiple fills of a single order may become common practice. Moreover, current systems do not net orders in real-time. As such, a multiplicity of original orders remains open with no possibility for creation of a single new order.

The CME's Average Pricing System (APS), further described below, can enable multiple orders to be grouped together and assigned a single average price across the group. However, the APS solution is specific to futures and options and does not extend to OTC products. Moreover, the APS solution does not address order grouping with the creation of a new trade, and original orders are not terminated to create a single new order. Rather, two separate orders in which the prices and all economics match will offset at the end of the day without the possibility for real-time netting, and subsequent termination.

By way of general introduction, a computer-implemented method for managing a plurality of orders for a financial instrument in accordance with the present teachings comprises: (a) accepting, by a processor, the plurality of orders for clearing; (b) sending/transmitting/communicating, by the processor, based on the accepting, a cleared confirmation message/notification indicating that the plurality of orders has been cleared; (c) receiving, by the processor, notification/indication of a desire to group the plurality of cleared orders/notification to group the plurality of cleared orders; (d) terminating, by the processor, the plurality of cleared orders and creating a new order as a replacement therefore (e.g., netting/combining, by the processor, the plurality of cleared orders to form a new order); and (e) sending/transmitting/communicating, by the processor, a cleared confirmation message/notification for the new order. Computer-implementation of a method in accordance with the present teachings may reduce the time in which individual orders, for a single bunched order, may be sent to the Clearing House. Thus, a bunched order need not be filled prior to submission to Clearing. Moreover, the process of order grouping may be further centralized since orders from multiple sources (e.g. SEFs) may be grouped together.

In some embodiments, the method comprises deriving a new order from the plurality of cleared orders, the derived order being substantially economically equivalent to the plurality of cleared orders. As used herein, the phrase “substantially economically equivalent” means that any difference in the values does not affect decisions that are made based on or derived from these values. In some embodiments, the derived order has an economic value that is substantially equivalent to a combined economic value of the plurality of cleared orders. In some embodiments, the economics of the new order substantially reflect the economics of the plurality of orders prior to grouping. In some embodiments, the method further comprises computing, by the processor, an average price for the new order which, in some embodiments, comprises a weighted average. In some embodiments, the financial instrument comprises an OTC derivative. In other embodiments, the financial instrument comprises an exchange-traded derivative.

The notification/indication of a desire to group a plurality of cleared orders and/or notification to group the plurality of cleared orders may be explicit or implicit. In some embodiments, the notification/indication is explicit (e.g., an instruction is directly received, for example by a processor, from an external source). In other embodiments, the notification/indication is implicit (e.g., criteria for grouping are pre-defined, such as prior to order submission to clearing).

In some embodiments, the notification is sent by a counterparty to an Exchange and, in some embodiments, the cleared confirmation message/notification for the new order is sent from the Exchange to the counterparty. Further, in some embodiments, the cleared confirmation message/notification for the new order is also sent to a third party. In some embodiments, the cleared confirmation message/notification for the new order is sent via the third party to the counterparty. In some embodiments, the third party is selected from the group consisting of custodians, affirmation platforms, backoffice providers, and combinations thereof.

A first system for electronically managing a plurality of orders for a financial instrument in accordance with the present teachings comprises a processor coupled to a non-transitory memory, wherein the processor is operative to execute computer program instructions to cause the processor to: (a) accept the plurality of orders for clearing; (b) send a cleared confirmation message/notification indicating that the plurality of orders has been cleared; (c) receive notification of a desire for the plurality of cleared orders to be grouped/receive notification instructions to group the plurality of cleared orders; (d) terminate the plurality of cleared orders and create a new order as a replacement therefore (e.g., net the plurality of cleared orders to form a new order); and (e) send a cleared confirmation message/notification for the new order.

A second system for electronically managing a plurality of orders for a financial instrument in accordance with the present teachings comprises a processor; a non-transitory memory coupled with the processor; first logic stored in the non-transitory memory and executable by the processor to cause the processor to accept the plurality of orders for clearing; second logic stored in the non-transitory memory and executable by the processor to cause the processor to send a cleared confirmation message/notification indicating that the plurality of orders has been cleared; third logic stored in the non-transitory memory and executable by the processor to cause the processor to receive notification of a desire for the plurality of cleared orders to be grouped/receive notification instructions to group the plurality of cleared orders; fourth logic stored in the non-transitory memory and executable by the processor to cause the processor to terminate the plurality of cleared orders and create a new order as a replacement therefore (e.g., net the plurality of cleared orders to form a new order); and fifth logic stored in the non-transitory memory and executable by the processor to cause the processor to send a cleared confirmation message/notification for the new order.

A third system for electronically managing a plurality of orders for a financial instrument in accordance with the present teachings comprises (a) means for accepting the plurality of orders for clearing; (b) means for sending a cleared confirmation message/notification indicating that the plurality of orders has been cleared; (c) means for receiving notification of a desire to group the plurality of cleared orders/means for receiving notification instructions to group the plurality of cleared orders; (d) means for terminating the plurality of cleared orders and creating a new order as a replacement therefore (e.g., means for netting the plurality of cleared orders to form a new order); and (e) means for sending a cleared confirmation message/notification for the new order.

A non-transitory computer-readable storage medium in accordance with the present teachings has stored therein data representing instructions executable by a programmed processor for electronically managing a plurality of orders for a financial instrument. The storage medium comprising instructions for: (a) accepting the plurality of orders for clearing; (b) sending a cleared confirmation message/notification indicating that the plurality of orders has been cleared; (c) receiving notification of a desire to group the plurality of cleared orders/receiving notification instructions to group the plurality of cleared orders; (d) terminating the plurality of cleared orders and creating a new order as a replacement therefore (e.g., netting the plurality of cleared orders to form a new order); and (e) sending a cleared confirmation message/notification for the new order.

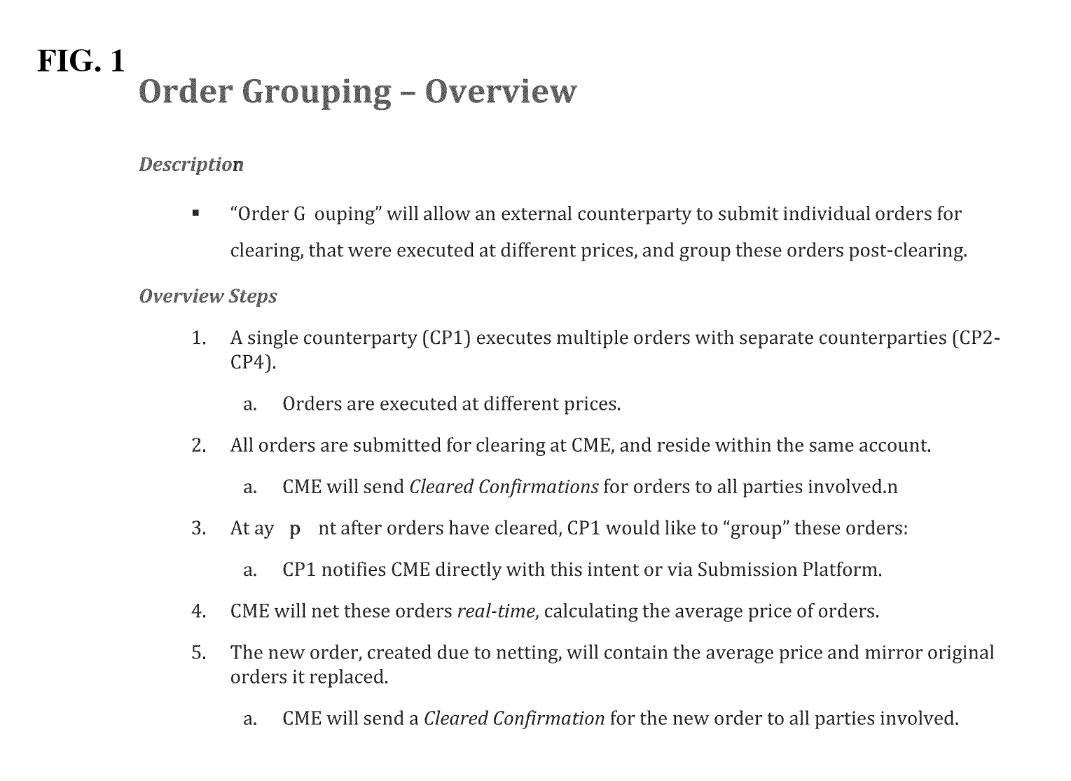

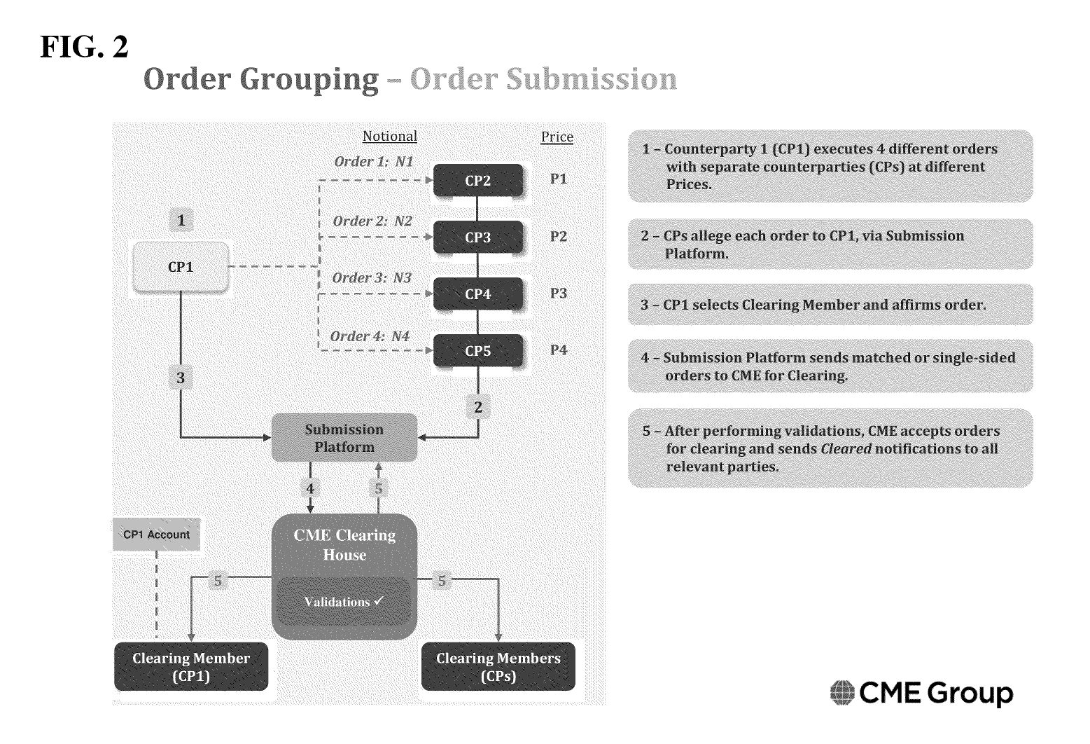

Further aspects of the present teachings will now be described in reference to the drawings. FIG. 1 shows an overview of order grouping in accordance with the present teachings. FIGS. 2, 3, and 4 depict flow charts showing exemplary operation of a representative system for managing a plurality of orders for a financial instrument in accordance with the present teachings.

FIG. 2 shows acts in a representative order submission sub-process in a representative order grouping process that embodies features of the present teachings. As shown in FIG. 2, a single counterparty (CP1) executes multiple orders (1) with separate counterparties (CP2-CP4). In some embodiments, one or more of the orders are executed at different prices. In other embodiments, each of the orders is executed at the same price. As further shown in FIG. 2, the counterparties allege each order to CP1 via submission platform (2), and CP1 selects a Clearing Member and affirms the order(s) (3). As used herein, the term “allege” refers to the act of one party providing a new trade to a counterparty and requiring affirmation of the trade details by the counterparty. As further shown in FIG. 2, the submission platform sends matched or single-sided orders to an Exchange (e.g., CME) for clearing (4). All orders submitted for clearing at the Exchange (e.g., CME) reside within the same account. Upon accepting and clearing the orders, the CME will send cleared confirmations for orders to all parties involved (5).

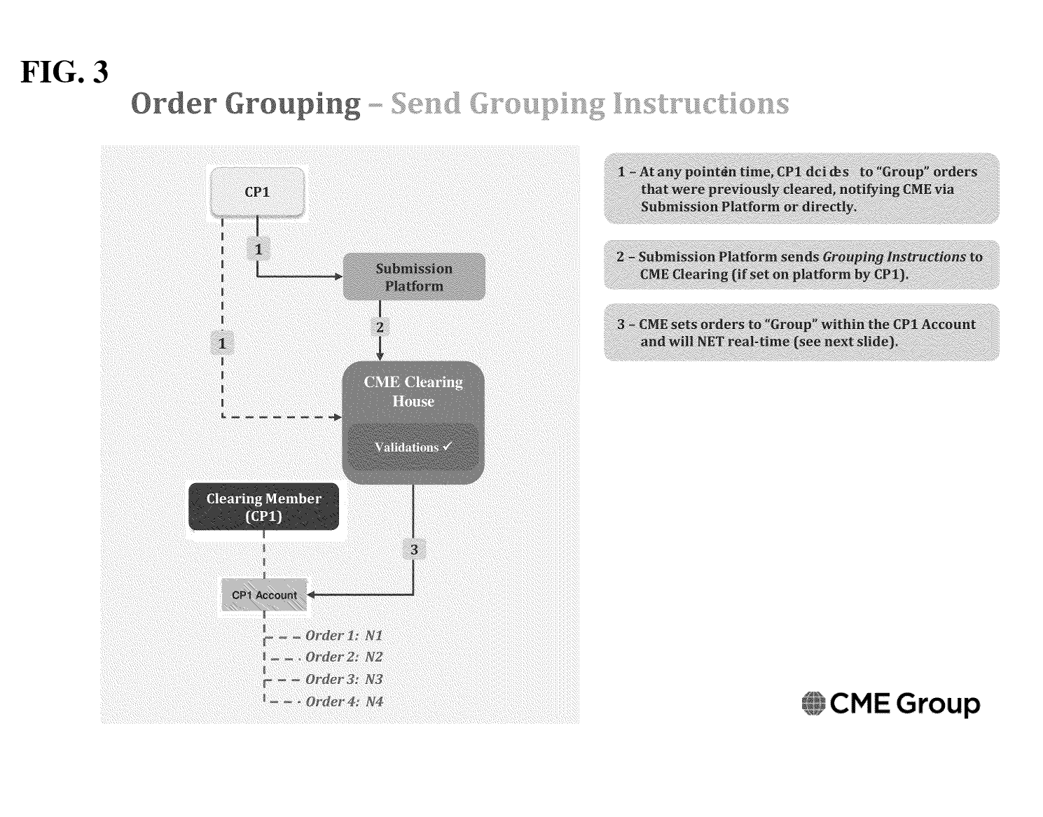

FIG. 3 shows acts in a representative grouping instructions sub-process in a representative order grouping process that embodies features of the present teachings. In some embodiments, as shown in FIG. 3, at any point after orders have cleared, CP1 may decide to “group” these orders, notifying the Exchange (e.g., CME) via submission platform or directly (1). In some embodiments, the submission platform sends grouping instructions to the CME clearing (e.g., if set on platform by CP1), as shown in FIG. 3 (2). In some embodiments, CP1 notifies the CME of its desire for grouping directly via the Application Programming Interface (API). In other embodiments, CP1 notifies the CME of its desire via a submission platform (using API). In some embodiments, as shown in FIG. 3, the Exchange (e.g., CME) sets orders to group within the CP1 account and will net orders in real time (3).

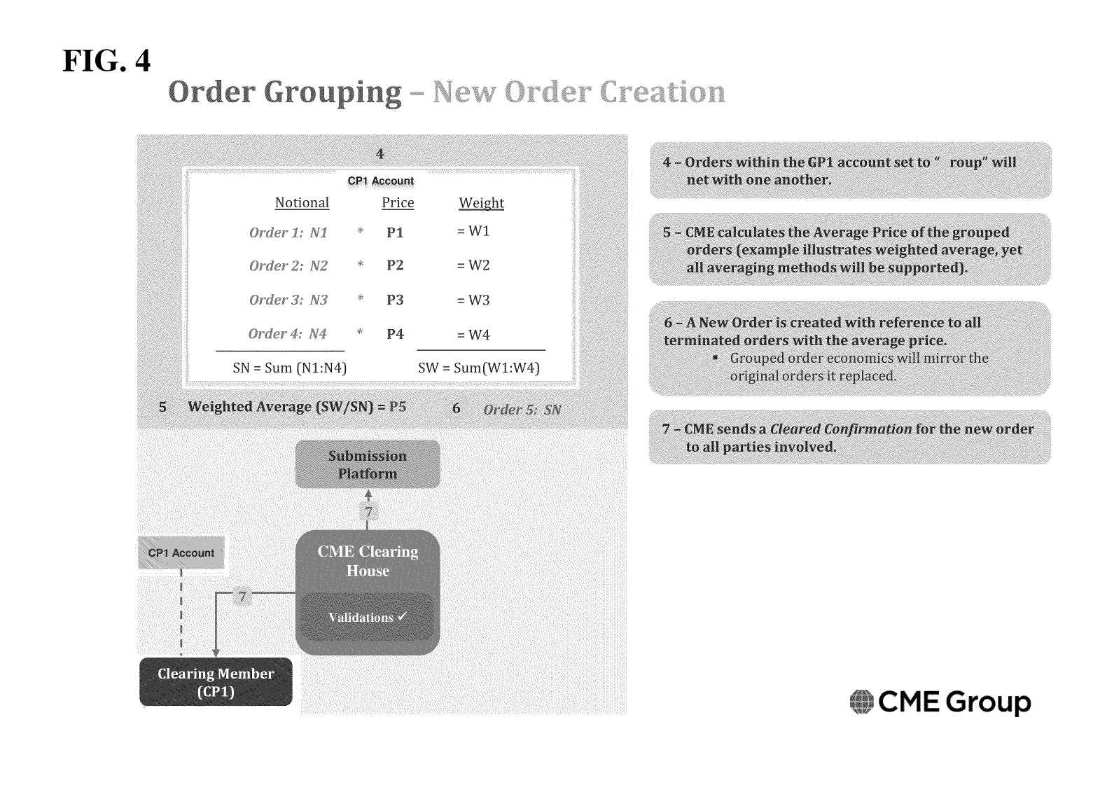

FIG. 4 shows acts in a representative new-order-creation sub-process in a representative order grouping process that embodies features of the present teachings. In some embodiments, orders within the CP1 account set to group will net with one another (4). In some embodiments, the CME will net the orders that have been cleared in real-time, calculating the average price of orders using an averaging method (5). It is to be understood that all manner of averages and methods for their calculation are contemplated for use in accordance with the present teachings, including but not limited to arithmetic means, medians, geometric medians, mode geometric means, harmonic means, quadratic means, generalized means, weighted means, truncated means, interquartile means, midranges, Winsorized means, annualization, and the like, and combinations thereof. In some embodiments, the average price comprises a weighted average.

In some embodiments, as shown in FIG. 4, the new order, created due to netting, will contain the average price and substantially mirror the economics of the original orders it replaces (6). As shown in FIG. 4, the CME will send a cleared confirmation for the new order to all parties involved (e.g., CP1, custodians, affirmation platforms, backoffice providers, and the like, and/or combinations thereof) (7).

In some embodiments, a new functionality is provided that is configured to (1) support a new “Grouping Instruction” message via API; (2) identify orders within the same account to be grouped; (3) net orders in real-time by creating a new netting cycle, with specific functionality (e.g., create a new order with economics of grouped orders); and/or (4) function to calculate the average price of grouped orders, with the ability to assign this price to a new order.

In some embodiments, a process of “Order Grouping” in accordance with the present teachings will allow external counterparties (e.g., Clients) to submit individual orders, as they have in the past, executed with separate counterparties at different prices. However, after the trades have been cleared, these counterparties will be provided with a new functionality, such as described herein.

Some embodiments in accordance with the present teachings may provide one or more of the following advantages: (1) external counterparties can have the ability to execute multiple small orders across the market at the best prices available, rather than being forced to execute one large order, which may not provide the best price; (2) the current order submission process can be leveraged; (3) the external counterparties can have the ability to send “grouping” instructions to the CME directly or via a submission platform (grouping instructions did not previously exist, and some embodiments in accordance with the present teachings can provide a semi-automated process via an API that eliminates manual processing); (4) the CME can automatically process the grouping instructions and net orders in real-time (previously, there was no way to set orders to “group” and the netting cycle was set to run only at the end of the day); and (5) using the prices specified on individual orders, the CME can automatically calculate the average price on grouped orders and assign this price to the new order (e.g., new functionality).

After execution of a trade by two counterparties—whether through an Exchange, as in the case of exchange-traded derivatives, or off-exchange in the OTC market, as in the case of OTC derivatives—the trade can be handed over to a Clearing House, which then steps between the two original trading entities (e.g., clearing firms) and assumes the legal counterparty risk for the trade (i.e., novation).

In some embodiments, the trade is executed off-exchange in the OTC market, and the financial instrument comprises an OTC derivative. In some embodiments, the plurality of orders for OTC derivatives to be grouped in accordance with the present teachings comprises orders executed at different times and/or at different prices and/or in different quantities. By way of non-limiting example, in some embodiments, a first order for x number of an OTC derivative is executed with a first counterparty at a first price at a first point in time, a second order for y number of the OTC derivative is executed with a second counterparty at a second different price at a second different point in time, . . . , and an n-th order for z number of the OTC derivative is executed with an n-th counterparty for an n-th different price at an n-th different point in time, wherein x, y, . . . , and z are the same or different, and wherein the sum of x+y+ . . . +z represents the total quantity of OTC derivative desired by the first counterparty. In some embodiments, a bilateral OTC trade is handed over to a bilateral clearing system that provides review and confirmation services for bilateral trades. One such bilateral clearing system includes but is not limited to the CME's “ConfirmHub.”

In alternative embodiments, a trade is executed through an Exchange (e.g., CME), and the financial instrument comprises an exchange-traded derivative. In some embodiments, the plurality of orders for exchange-traded derivatives to be grouped in accordance with the present teachings comprises orders executed at different times (e.g., during the course of a given trading day and/or on different trading days) and/or at different prices and/or in different quantities. By way of non-limiting example, in some embodiments, a first order for x number of an exchange-traded derivative is executed with an Exchange at a first price at a first point in time, a second order for y number of the exchange-traded derivative is executed with the same Exchange at a second different price at a second different point in time, . . . , and an n-th order for z number of the exchange-traded derivative is executed with the same Exchange for an n-th different price at an n-th different point in time, wherein x, y, . . . , and z are the same or different, and wherein the sum of x+y+ . . . +z represents the total quantity of exchange-traded derivative desired by the first counterparty.

As noted above, the CME's Average Pricing System is specific to futures and options and does not extend to OTC products. Notwithstanding, the APS will now be described in more detail.

The CME's Average Price System allows a clearing firm to confirm to customers an average price when multiple execution prices are received on an order or series of orders for futures, options or combination transactions. An order or series of orders executed during a Regular Trading Hours Session at more than one price may only be averaged pursuant to APS if each order is for the same account or group of accounts and for the same commodity and month for futures, or for the same commodity, month, put/call and strike for options.

Any member or Clearing Member that accepts an order subject to APS must include an APS indicator on the order at the time of acceptance, and must comply with all other order requirements including those set forth in Rule 536. The APS indicator should appear on the office order and floor order.

Upon receipt of an execution at multiple prices for an order with an APS indicator, an average will be computed by multiplying the execution prices by the quantities at those prices divided by the total quantities. An average price for a series of orders will be computed based on the average prices of each order in that series. The actual average price or the average price rounded to the next price increment may be confirmed to customers. If a Clearing Member confirms the rounded average price, the Clearing Member must round the average price to the next price increment for a buy order or to the next price increment for a sell order. The residual created by the rounding process is paid to the customer. APS may produce prices that do not conform to whole cent increments. In such cases, the Clearing Member may retain any amounts less than one cent.

Each Clearing Member that confirms an average price to a customer should indicate on the confirmation and monthly statement that the price represents an average price.

The APS will enable a Clearing Member to confirm to customers an average price when multiple prices are received on an order or series of orders for the same accounts. For example, if an order transmitted by an account manager on behalf of several customers is executed at more than one price, those prices may be averaged and the average may be confirmed to each customer. Customers will have the choice of participating in APS.

An APS order may be used for futures, options or combination transactions. An APS order for futures is for the same commodity and month, and for options, it is for the same commodity, month put/call and strike.

The CME computes the average by multiplying the price by the quantity executed at each price divided by the total quantity.

The APS process is not limited to discretionary accounts, and may also be used for a non-discretionary account upon request of a customer.

An APS indicator will appear on a customer's confirmation and monthly statement for a position that has been confirmed at an average price. This indicator will notify the customer that the confirmed price represents an average price or rounded average price.

Prior to entering an order for a customer, a firm should describe certain features of APS to customers. For example, a firm should inform a customer that the average price is not the actual execution price and that APS will calculate the same price for all customers that participate in the order. Each clearing firm should decide how to communicate this information to the customer.

It is believed that provision of the information to the pool operator by the firm will satisfy any disclosure obligation to a commodity pool. APS can be used when a series of orders are entered for a group of accounts. A bunched APS order (an order that represents more than one customer account) executed at 10:00 am could be averaged with a bunched APS order executed at 12:00 pm. provided that each of the bunched orders is for the same accounts. In addition, market orders and limit orders may be averaged, as may limit orders at different prices, provided that each order is for the same accounts.

In some embodiments, an APS order is only partially executed. For example, at 10:00 am a buy 100 APS DEC S&P 500 futures order is transmitted at a limit price of 376.00; 50 are executed at 376.00, and the balance is not filled. At 12.00 p.m. a buy 100 APS DEC S&F 500 futures order is transmitted at a limit price of 375.00; 50 are executed at 375.00 and the balance is not filled. Both orders are part of a series for the same group of accounts. In this example, the two prices will be averaged. If the order was placed for more than one account, the account controller must rely on pre-existing allocation procedures to determine the proportions in which each account will share in the partial fill.

There is no requirement that a firm confirm the average price rather than the rounded average price. Each firm will have the choice of confirming the actual average price or the average price rounded to the next price increment. If a clearing firm confirms the rounded average price, the firm should round the average price up to the next price increment for a buy order or down to the next price increment for a sell order. The rounding process will create a cash residual of the difference between actual average price and the rounded average price that must be paid to the customer.

If the actual average or the residual is a price that does not conform to a whole cent increment, APS may produce prices that do not conform to whole cent increments. In such cases, the Clearing Member may retain any amount less than one cent. For example, if the total residual to be paid to a customer on a rounded average price for 10 contracts is $83.333333, the clearing firm may pay to the customer $83.33.

A customer will be able to obtain information regarding the actual execution prices of a trade that has been confirmed at an average price. The customer should contact the firm carrying the customer's account to obtain the actual execution prices. If the firm did not execute the trade, the firm will have to contact the executing firm to obtain the information.

One skilled in the art will appreciate that one or more modules or logic described herein may be implemented using, among other things, a tangible computer-readable medium comprising computer-executable instructions (e.g., executable software code). Alternatively, modules may be implemented as software code, firmware code, hardware, and/or a combination of the aforementioned. For example the modules may be embodied as part of an Exchange for financial instruments.

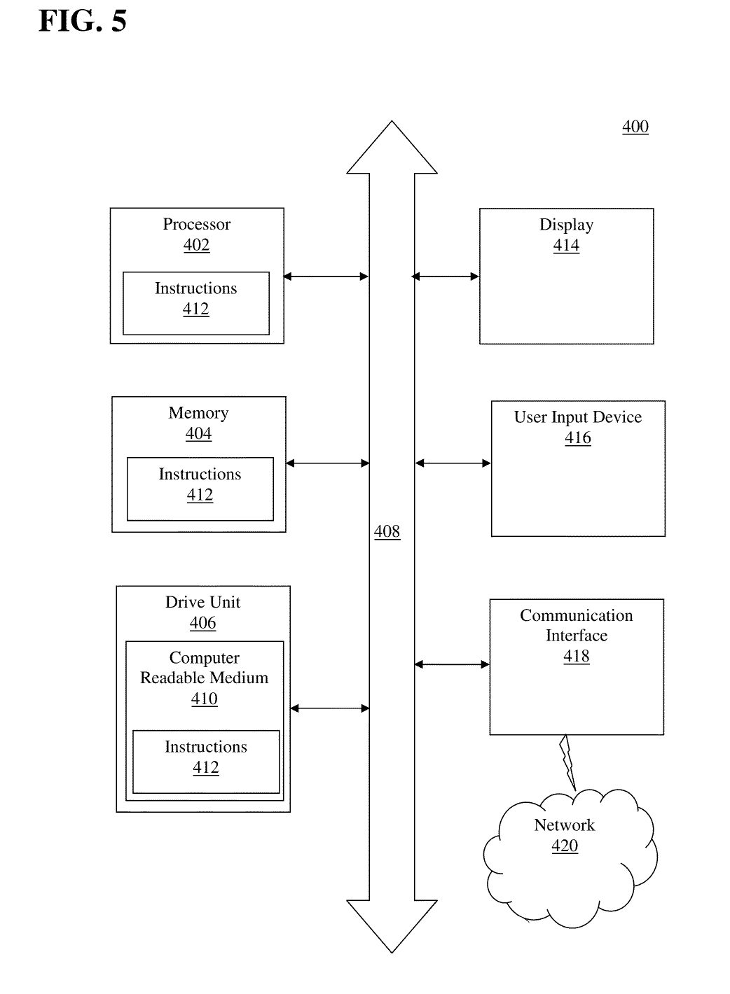

FIG. 5 depicts an illustrative embodiment of a general computer system 400. The computer system 400 can include a set of instructions that can be executed to cause the computer system 400 to perform any one or more of the methods or computer based functions disclosed herein. The computer system 400 may operate as a standalone device or may be connected (e.g., using a network) to other computer systems or peripheral devices. Any of the components discussed above, such as the processor, may be a computer system 400 or a component in the computer system 400. The computer system 400 may implement an order-grouping engine on behalf of an Exchange, such as the Chicago Mercantile Exchange, of which the disclosed embodiments are a component thereof.

In a networked deployment, the computer system 400 may operate in the capacity of a server or as a client user computer in a client-server user network environment, or as a peer computer system in a peer-to-peer (or distributed) network environment. The computer system 400 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In some embodiments, the computer system 400 can be implemented using electronic devices that provide voice, video or data communication. Further, while a single computer system 400 is illustrated, the term “system” shall also be taken to include any collection of systems or sub-systems that individually or jointly execute a set, or multiple sets, of instructions to perform one or more computer functions.

As shown in FIG. 5, the computer system 400 may include a processor 402, for example a central processing unit (CPU), a graphics-processing unit (GPU), or both. The processor 402 may be a component in a variety of systems. For example, the processor 402 may be part of a standard personal computer or a workstation. The processor 402 may be one or more general processors, digital signal processors, application specific integrated circuits, field programmable gate arrays, servers, networks, digital circuits, analog circuits, combinations thereof, or other now known or later developed devices for analyzing and processing data. The processor 402 may implement a software program, such as code generated manually (i.e., programmed).

The computer system 400 may include a memory 404 that can communicate via a bus 408. The memory 404 may be a main memory, a static memory, or a dynamic memory. The memory 404 may include, but is not limited to, computer-readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In some embodiments, the memory 404 includes a cache or random access memory for the processor 402. In alternative embodiments, the memory 404 is separate from the processor 402, such as a cache memory of a processor, the system memory, or other memory. The memory 404 may be an external storage device or database for storing data. Examples include a hard drive, compact disc (CD), digital video disc (DVD), memory card, memory stick, floppy disc, universal serial bus (USB) memory device, or any other device operative to store data. The memory 404 is operable to store instructions executable by the processor 402. The functions, acts or tasks illustrated in the figures or described herein may be performed by the programmed processor 402 executing the instructions 412 stored in the memory 404. The functions, acts or tasks are independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

As shown in FIG. 5, the computer system 400 may further include a display unit 414, such as a liquid crystal display (LCD), an organic light emitting diode (OLED), a flat panel display, a solid state display, a cathode ray tube (CRT), a projector, a printer or other now known or later developed display device for outputting determined information. The display 414 may act as an interface for the user to see the functioning of the processor 402, or specifically as an interface with the software stored in the memory 404 or in the drive unit 406.

Additionally, as shown in FIG. 5, the computer system 400 may include an input device 416 configured to allow a user to interact with any of the components of system 400. The input device 416 may be a number pad, a keyboard, or a cursor control device, such as a mouse, or a joystick, touch screen display, remote control or any other device operative to interact with the system 400.

In some embodiments, as shown in FIG. 5, the computer system 400 may also include a disk or optical drive unit 406. The disk drive unit 406 may include a computer-readable medium 410 in which one or more sets of instructions 412 (e.g., software) can be embedded. Further, the instructions 412 may embody one or more of the methods or logic as described herein. In some embodiments, the instructions 412 may reside completely, or at least partially, within the memory 404 and/or within the processor 402 during execution by the computer system 400. The memory 404 and the processor 402 also may include computer-readable media as described above.

The present teachings contemplate a computer-readable medium that includes instructions 412 or receives and executes instructions 412 responsive to a propagated signal, so that a device connected to a network 420 can communicate voice, video, audio, images or any other data over the network 420. Further, the instructions 412 may be transmitted or received over the network 420 via a communication interface 418. The communication interface 418 may be a part of the processor 402 or may be a separate component. The communication interface 418 may be created in software or may be a physical connection in hardware. The communication interface 418 is configured to connect with a network 420, external media, the display 414, or any other components in system 400, or combinations thereof. The connection with the network 420 may be a physical connection, such as a wired Ethernet connection or may be established wirelessly as discussed below. Likewise, the additional connections with other components of the system 400 may be physical connections or may be established wirelessly.

The network 420 may include wired networks, wireless networks, or combinations thereof. The wireless network may be a cellular telephone network, an 802.11, 802.16, 802.20, or WiMax network. Further, the network 420 may be a public network, such as the Internet, a private network, such as an intranet, or combinations thereof, and may utilize a variety of networking protocols now available or later developed including, but not limited to TCP/IP based networking protocols.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of subject matter described in this specification can be implemented as one or more computer program products, for example, one or more modules of computer program instructions encoded on a computer-readable medium for execution by, or to control the operation of, data processing apparatus. While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein. The computer-readable medium can be a machine-readable storage device, a machine-readable storage substrate, a memory device, or a combination of one or more of them. The term “data processing apparatus” encompasses all apparatuses, devices, and machines for processing data, including but not limited to, by way of example, a programmable processor, a computer, or multiple processors or computers. The apparatus can include, in addition to hardware, code that creates an execution environment for the computer program in question (e.g., code that constitutes processor firmware, a protocol stack, a database management system, an operating system, or a combination thereof).

In some embodiments, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the present teachings are considered to include any one or more of a computer-readable medium or a distribution medium and other equivalents and successor media, in which data or instructions may be stored.

In some embodiments, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In some embodiments, the methods described herein may be implemented by software programs executable by a computer system. Further, in some embodiments, implementations can include distributed processing, component/object distributed processing, and parallel processing. Alternatively, virtual computer system processing can be constructed to implement one or more of the methods or functionality as described herein.

Although the present teachings describe components and functions that may be implemented in particular embodiments with reference to particular standards and protocols, the present invention is not limited to such standards and protocols. For example, standards for Internet and other packet switched network transmission (e.g., TCP/IP, UDP/IP, HTML, HTTP, HTTPS) represent examples of the state of the art. Such standards are periodically superseded by faster or more efficient equivalents having essentially the same functions. Accordingly, replacement standards and protocols having the same or similar functions as those disclosed herein are considered equivalents thereof.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described herein can be performed by one or more programmable processors executing one or more computer programs to perform functions by operating on input data and generating output. The processes and logic flows can also be performed by, and apparatus can also be implemented as, special purpose logic circuitry, for example, an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The main elements of a computer are a processor for performing instructions and one or more memory devices for storing instructions and data. Generally, a computer will also include, or be operatively coupled to receive data from or transfer data to, or both, one or more mass storage devices for storing data, for example, magnetic, magneto optical disks, or optical disks. However, a computer need not have such devices. Moreover, a computer can be embedded in another device, for example, a mobile telephone, a personal digital assistant (PDA), a mobile audio player, a Global Positioning System (GPS) receiver, to name just a few. Computer-readable media suitable for storing computer program instructions and data include all forms of non volatile memory, media and memory devices, including but not limited to, by way of example, semiconductor memory devices (e.g., EPROM, EEPROM, and flash memory devices); magnetic disks (e.g., internal hard disks or removable disks); magneto optical disks; and CD ROM and DVD-ROM disks. The processor and the memory can be supplemented by, or incorporated in, special purpose logic circuitry.

To provide for interaction with a user, some embodiments of subject matter described herein can be implemented on a device having a display, for example a CRT (cathode ray tube) or LCD (liquid crystal display) monitor, for displaying information to the user and a keyboard and a pointing device, for example a mouse or a trackball, by which the user can provide input to the computer. Other kinds of devices can be used to provide for interaction with a user as well. By way of example, feedback provided to the user can be any form of sensory feedback (e.g., visual feedback, auditory feedback, or tactile feedback); and input from the user can be received in any form, including but not limited to acoustic, speech, or tactile input.

Embodiments of subject matter described herein can be implemented in a computing system that includes a back-end component, for example, as a data server, or that includes a middleware component, for example, an application server, or that includes a front end component, for example, a client computer having a graphical user interface or a Web browser through which a user can interact with an implementation of the subject matter described in this specification, or any combination of one or more such back end, middleware, or front end components. The components of the system can be interconnected by any form or medium of digital data communication, for example, a communication network. Examples of communication networks include but are not limited to a local area network (LAN) and a wide area network (WAN), for example, the Internet.

The computing system can include clients and servers. A client and server are generally remote from each other and typically interact through a communication network. The relationship of client and server arises by virtue of computer programs running on the respective computers and having a client-server relationship to each other.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings and described herein in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 CFR §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

It is to be understood that the elements and features recited in the appended claims may be combined in different ways to produce new claims that likewise fall within the scope of the present invention. Thus, whereas the dependent claims appended below depend from only a single independent or dependent claim, it is to be understood that these dependent claims can, alternatively, be made to depend in the alternative from any preceding claim—whether independent or dependent—and that such new combinations are to be understood as forming a part of the present specification.

The foregoing detailed description and the accompanying drawings have been provided by way of explanation and illustration, and are not intended to limit the scope of the appended claims. Many variations in the presently preferred embodiments illustrated herein will be apparent to one of ordinary skill in the art, and remain within the scope of the appended claims and their equivalents.

1. A computer-implemented method for managing a plurality of orders for a financial instrument, the method comprising:
accepting, by a processor, the plurality of orders for clearing;
sending, by the processor, based on the accepting, a cleared confirmation message indicating that the plurality of orders has been cleared;
receiving, by the processor, notification to group the plurality of cleared orders;
terminating, by the processor, the plurality of cleared orders and creating a new order; and
sending, by the processor, a cleared confirmation message for the new order.

2. The computer-implemented method of claim 1 wherein economics of the new order substantially reflect economics of the plurality of orders prior to grouping.

3. The computer-implemented method of claim 1 further comprising computing, by the processor, an average price for the new order.

4. The computer-implemented method of claim 3 wherein the average price comprises a weighted average.

5. The computer-implemented method of claim 1 wherein the financial instrument comprises an OTC derivative.

6. The computer-implemented method of claim 1 wherein the financial instrument comprises an exchange-traded derivative.

7. The computer-implemented method of claim 1 wherein the notification is sent by a counterparty to an Exchange.

8. The computer-implemented method of claim 7 wherein the cleared confirmation message for the new order is sent from the Exchange to the counterparty.

9. The computer-implemented method of claim 8 wherein the cleared confirmation message for the new order is also sent to a third party.

10. The computer-implemented method of claim 9 wherein the third party is selected from the group consisting of custodians, affirmation platforms, backoffice providers, and combinations thereof.

11. A system for electronically managing a plurality of orders for a financial instrument, the system comprising:
a processor coupled to a non-transitory memory, wherein the processor is operative to execute computer program instructions to cause the processor to:
(a) accept the plurality of orders for clearing;
(b) send a cleared confirmation message indicating that the plurality of orders has been cleared;
(c) receive notification instructions to group the plurality of cleared orders;
(d) terminate the plurality of cleared orders and create a new order; and
(e) send a cleared confirmation message for the new order.

12. The system of claim 11 wherein economics of the new order substantially reflect economics of the plurality of orders prior to grouping.

13. The system of claim 11 wherein the processor is further operative to execute computer program instructions to cause the processor to compute an average price for the new order.

14. The system of claim 13 wherein the average price comprises a weighted average.

15. The system of claim 11 wherein the financial instrument comprises an OTC derivative.

16. The system of claim 11 wherein the financial instrument comprises an exchange-traded derivative.

17. The system of claim 11 wherein the notification instructions are sent by a counterparty to an Exchange.

18. The system of claim 17 wherein the cleared confirmation message for the new order is sent from the Exchange to the counterparty.

19. The system of claim 18 wherein the cleared confirmation message for the new order is also sent to a third party.

20. The system of claim 19 wherein the third party is selected from the group consisting of custodians, affirmation platforms, backoffice providers, and combinations thereof.

21. A system for electronically managing a plurality of orders for a financial instrument, the system comprising:
a processor;
a non-transitory memory coupled with the processor;
first logic stored in the non-transitory memory and executable by the processor to cause the processor to accept the plurality of orders for clearing;
second logic stored in the non-transitory memory and executable by the processor to cause the processor to send a cleared confirmation message indicating that the plurality of orders has been cleared;
third logic stored in the non-transitory memory and executable by the processor to cause the processor to receive notification instructions to group the plurality of cleared orders;
fourth logic stored in the non-transitory memory and executable by the processor to cause the processor to terminate the plurality of cleared orders and create a new order; and
fifth logic stored in the non-transitory memory and executable by the processor to cause the processor to send a cleared confirmation message for the new order.

22. A system for electronically managing a plurality of orders for a financial instrument, the system comprising:
means for accepting the plurality of orders for clearing;
means for sending a cleared confirmation message indicating that the plurality of orders has been cleared;
means for receiving notification instructions to group the plurality of cleared orders;
means for terminating the plurality of cleared orders and creating a new order; and
means for sending a cleared confirmation message for the new order.

23. In a non-transitory computer-readable storage medium having stored therein data representing instructions executable by a programmed processor for electronically managing a plurality of orders for a financial instrument, the storage medium comprising instructions for:
accepting the plurality of orders for clearing;
sending a cleared confirmation message indicating that the plurality of orders has been cleared;
receiving notification instructions to group the plurality of cleared orders;
terminating the plurality of cleared orders and creating a new order; and
sending a cleared confirmation message for the new order.
